(19) United States
(12) Patent Application Publication
(10) Pub. No.: US 2026/0200682 A1
(43) Pub. Date: Jul. 16, 2026

(54) METHOD FOR AUTOMATICALLY LOADING AND/OR UNLOADING A TRUCK AT A LOADING REGION AND SENSOR SYSTEM FOR SAFEGUARDING THE AUTOMATIC LOADING AND/OR UNLOADING OF THE TRUCK

(71) Applicant: SICK AG, Waldkirch (DE)

(72) Inventors: Markus HAMMES, Freiburg (DE); Jörg SIGMUND, Kenzingen (DE); Nikolaus MAYER, Freiburg (DE); Sandeep KADIYAM, Freiburg (DE)

(21) Appl. No.: 19/444,697

(22) Filed: Jan. 9, 2026

(30) Foreign Application Priority Data
Jan. 10, 2025 (EP) 25151256.2

(51) Int. Cl. B65G 43/00; B65G 67/20; B65G 67/24

(52) U.S. Cl. CPC B65G 43/00; B65G 67/20; B65G 67/24; B65G 2203/041; B65G 2203/044; B65G 2207/40

(57) ABSTRACT

An embodiment of the invention relates to a method for automatically loading and/or unloading a truck at a loading region, wherein the loading region has at least one access point that is provided with an optical counting device. Said optical counting device is configured to optically detect a number of passages of persons via the access point. The method comprises the following steps:
docking the truck at the loading region,
activating the loading and/or unloading,
loading and/or unloading items to be loaded using at least one autonomous vehicle while continuously monitoring the at least one access point by means of the optical counting device. In this respect, the loading and/or unloading is/are interrupted as soon as the counting device detects a passage of at least one person via the at least one access point.

The present invention relates to a method for automatically loading and/or unloading a truck at a loading region and to a sensor system for safeguarding this automatic loading and/or unloading of the truck.

Due to automation, regions that are safe for humans, which are free of dangerous machines or automatic equipment, and regions that are not safe for persons, in which dangerous machines or self-driving, automatically controlled vehicles are located from which humans must in particular be protected, are produced in factories and industrial plants. One possible application scenario is the automatic loading and unloading of trucks. The aim here is to automate a manual loading and unloading using human labor, for example forklift drivers, in order to reduce costs and to reduce a dependency on the availability of this human workforce.

Specifically, in the envisaged application, trucks are to be loaded and/or unloaded at loading bays of factories or logistics centers with the aid of automated guided vehicles (AGVs). For example, after the docking of a truck, such autonomous vehicles pick up goods from the loading space of the truck and take them to a destination, for example a warehouse of a factory, or vice versa: goods from the warehouse or factory are loaded into the truck for a transporting away. Due to the cramped conditions in the loading space of the truck, the poor visibility and the lack of escape or evasion possibilities for persons, a loading and unloading with the currently known safety sensors cannot be safeguarded with reasonable effort or only with considerable restrictions for the productivity of the automated process, and thus cannot be automated either. The manual loading and unloading causes high costs and leads to a bottleneck in a logistics sequence due to the possible low availability of labor.

Known safety sensors, for example safety laser scanners, safeguard travel movements of AGVs with the aid of protective fields that detect the travel region in the direction of travel. When the vehicle drives around tight bends or enters a dead end, it is necessary to dynamically adjust or completely deactivate protective fields of the AGV depending on the situation. Thus, objects or walls should be prevented from falsely triggering the protective field function and stopping the AGV from moving. However, it is precisely these conditions that are inevitably present during the automatic loading and unloading of a truck. An extension of the safety sensor system to 3D systems does not provide a solution in this regard since the 3D protective fields of the AGV would also have to be adapted to the cramped conditions or completely deactivated in this case.

Known approaches for realizing an automated loading and unloading of trucks are based, for example, on specifically designed loading bays that prepare goods outside the truck and then drive them into the truck with the aid of a specific loading system. For this purpose, it is necessary that the trucks meet specific requirements to be able to be automatically loaded and unloaded. The factory-side part of this solution must in each case be permanently installed at a loading bay, which entails high costs. An additional transfer process is also produced with these special solutions. Even with these solutions, it is not possible to use automated guided vehicles directly for an automatic loading and unloading of trucks while maintaining the required safety.

An object of the invention consequently comprises specifying a solution for a safe loading and unloading of a truck using an autonomous vehicle.

The object is satisfied by a method and the sensor system of the independent claims. Further developments and embodiments of the invention are the subject of the dependent claims in each case.

One embodiment of the invention relates to a method for automatically loading and/or unloading a truck at a loading region, wherein the loading region has at least one access point that is provided with an optical counting device. Said optical counting device is configured to optically detect a number of passages of persons via the access point. The method comprises the following steps:
docking the truck at the loading region,
activating the loading and/or unloading,
loading and/or unloading items to be loaded using at least one autonomous vehicle while continuously monitoring the at least one access point by means of the optical counting device. In this respect, the loading and/or unloading is/are interrupted as soon as the counting device detects a passage of at least one person via the at least one access point.

With the proposed method, an automatic loading and unloading of a truck using the at least one autonomous vehicle is made possible in a manner that is safe for persons. This is substantially achieved by using the optical counting device at the access point of the loading region at which the truck docks. With the aid of the optical counting device, the at least one access point via which, for example, persons can enter the loading region, is continuously monitored. As soon as the counting device detects the passage of at least one person via the access point, i.e. the access of a person to the loading region, the automatic loading and/or unloading is/are interrupted. In this respect, the autonomous vehicle can also be referred to as an AGV as defined above.

The proposed method does not require a loading system that is specifically designed for this purpose, as is described in the prior art. Knowledge about the presence of persons in the loading region is obtained via a reliable counting of the entries or exits, i.e. passages, of persons via the access point to/from the loading region using the optical counting device. The automatic loading and unloading of the truck is continued until the optical counting device detects the access of a person to the loading region. The method can be implemented cost-effectively and is largely independent of the availability of workers who drive a forklift truck.

The loading region is a region within a factory or an industrial plant which is delimited in a structural manner or in another manner and at which the truck can be docked from the outside. This, for example, takes place by precisely reversing the truck to a loading ramp or a docking gate so that the truck is positioned at a right angle to the ramp and a loading bridge rests securely on a loading region of the truck. Within the loading region, at least one autonomous vehicle performs the loading or unloading of the truck. In this respect, the AGV traverses, i.e. passes, the access point under certain circumstances. Persons only have access to the loading region via the access point.

In a further development, the interruption of the loading and/or unloading of the truck comprises a suppression of an autonomous movement of the at least one autonomous vehicle in the loading region by transmitting at least one control signal to the at least one vehicle.

As soon as the optical counting device detects the access of a person to the loading region, a control signal is transmitted to the autonomous vehicles operating in the loading region, for example via a secure interface or a communication interface between the optical counting device or a higher-ranking control unit and the respective autonomous vehicle, whereby further autonomous movements by the AGVs located in the loading region can no longer be carried out. This state can also be designated as a locking state. In this state, no autonomous movements of the autonomous vehicles are permitted. In addition, it is possible to switch to other safeguarding systems. The safety of persons entering the loading region or the loading zone is thus ensured.

According to a further development, the at least one access point is provided with a further optical counting device. Alternatively, the loading region has a further access point that is provided with the further optical counting device. The further optical counting device is configured to optically detect a further number of passages of persons via the access point or the further access point. The method additionally comprises forming a total count on the basis of the number and the further number of passages of persons via the access point and/or the further access point.

In this further development, two or more optical counting devices are provided. If the loading region, for example, extends over an intersection or a high-bay warehouse, the counting devices are arranged at separate access points. If an access point covers a larger spatial region, two or more optical counting devices are arranged at one access point. The optical counting devices are functionally of identical design. A total count is determined on the basis of the numbers of passages of persons determined by the optical counting devices in each case. The total count thus represents a balance of the numbers of passages determined by the individual counting devices. The entry of the loading region by a person-regardless of via which access point-causes an increase in the total count by one, while the leaving of the loading region by a person via any access point leads to a reduction of the total count by one. If a plurality of access points and/or a plurality of counting devices and the total count are used, the loading and/or unloading can be interrupted as soon as the total count deviates from a predetermined value, wherein the predetermined value is preferably zero (i.e. no person may be present in the loading region).

According to the invention, each access point to the loading region can be provided with at least one optical counting device. In the proposed method, the presence of persons in the loading region is concluded by counting the entries and/or exits to or from the loading region. The loading region is designed such that it can at least be be entered and exited by persons only via the access point(s). If there is exactly one access point, it is e.g. located at the position at which the truck docks at the loading region, i.e., for example, at the docking gate. Each access point can be passed by persons and AGVs. With each optical counting device, the passing, the crossing or the passage of a person is reliably recognized and is distinguished from the crossing by an AGV.

The geometry of the loading region is not subject to any further requirements and is therefore arbitrary. The proposed solution is therefore also suitable for the use with complex geometries, for example angled geometries, that cannot be safeguarded by a monitoring by conventional laser scanners.

According to a further development, the activation of the loading and/or unloading takes place by an operator or in an automated manner after the evaluation of the number determined by the at least one optical counting device or of a total count. In particular, this can take place using at least one further sensor, for example a radar sensor. In this respect, it is ensured that no person is located in a loading space of the truck and the loading region.

After the docking of the truck at the loading region, the automatic loading and unloading are explicitly activated. This can take place by a single intervention by an operator. The operator is convinced that the loading space is clear of persons and confirms this state in the system. Alternatively, the number that was determined by the at least one counting device or a total count, which is formed from the respective determined numbers if a plurality of optical counting devices are present, is evaluated in this respect. In addition, one or more further sensors can be used and evaluated for this purpose. A radar sensor can, for example, detect the smallest movements such as the breathing or heartbeat of a person and can thus provide information as to whether one or more persons are located in the loading space of the truck and/or in the loading region. Alternatively, a sensor of the optical counting device itself, for example a 3D camera, can be reused for this purpose. In this respect, the further sensor(s) used is/are advantageously arranged such that they each see a different perspective of the loading region in order thus to cover the entire loading region as far as possible. Thus, the presence of persons in the loading region that represents a hazardous zone can be detected and the activation of the automatic loading and unloading can only take place once it has been established that there are no persons in the hazardous zone.

In a further embodiment, the activation of the loading and/or unloading comprises releasing the autonomous movement of the at least one vehicle in the loading region by transmitting at least one further control signal. Furthermore, the activation starts the detection of the number of passages via the at least one access point.

As soon as it is ensured that there is no person in the loading space of the truck or in the loading region, the loading or unloading is started or continued and autonomous movements, i.e. movements that are controlled exclusively by a vehicle control of the AGV itself, are made possible. In other words, the above-mentioned locking state is canceled. A control of the movements of the AGVs in the loading region is fed back to the respective vehicle control. After the activation, at least one optical counting device monitors the entry and exit of persons to and from the loading region and allows the automatic loading/unloading process in which AGVs pass the at least one access point, as long as no access by a person is detected. This can, for example, be checked based on the check of the number of persons determined by the or each optical counting device or on the total count. If this number or the total count is equal to zero, the loading region is free of persons.

According to a further development, the optical detection of the number or the further number of passages of persons via the access point comprises the following in each case:
detecting a first number of passages via the access point using a first measurement channel of the optical counting device,
simultaneously detecting a second number of passages via the access point using the first or a second measurement channel of the optical counting device, comparing the first number with the second number, and
providing a result signal on the basis of the comparison, wherein the result signal indicates an error condition when the first number is not equal to the second number,
providing the first or the second number as the count of the optical counting device if the first number matches the second number.

Each passage of a person via an access point is therefore simultaneously detected by two different measurement channels. Each measurement channel provides a number. If the numbers of both measurement channels match, one of the numbers is output as the count. If the numbers do not match, an error condition is indicated by the result signal. The error condition, for example, indicates an incorrect functioning of the optical counting device or an unclear recognition if, for example, a plurality of persons pass the access point at the same time or if a person cannot be reliably recognized due to a taken-along item. In each of these cases, the error condition can be responded to by transmitting a control signal that prevents further autonomous movements in the loading region to all the autonomous vehicles in the loading region. The safety for persons is thus ensured at all times.

In a further development, the detection of the second number of passages via the at least one access point using the second measurement channel of the optical counting device comprises an evaluation of sensor data that are determined in the second measurement channel. The sensor data in particular comprise three-dimensional image data. In this respect, the evaluation takes place using artificial intelligence methods, in particular using a classifying neural network that is trained to evaluate the determined sensor data according to at least one predefined feature.

This feature can be, for example, a pattern of a typical head and shoulder area of a human. The taught feature can advantageously be used by the artificial intelligence, as a learning system, as a basis for automatically deriving complex signatures. The neural network is, for example, implemented as a convolutional neural network. Said convolutional neural network is trained in advance using synthetic or real training data. For this purpose, annotated or labeled training data are used that each show a person or an object. A classifying person and object recognition is thus made possible.

In a further development, the method additionally comprises evaluating the result signal of the optical counting device and interrupting the loading and/or unloading if the result signal indicates an error condition. The evaluation of the result signal comprises a comparative check of the sensor data that are determined in the first and the second measurement channel at the same time in each case.

If the first and the second measurement channel of a respective counting device determine different sensor data, this is interpreted as an indication of an error condition, which is indicated by the result signal. In the event of such an unclear or ambiguous recognition situation, which is reflected in the different sensor data, the automatic loading and/or unloading of the truck is/are interrupted for safety reasons. Thus, it is in any case prevented that a person enters the loading region without the automatic loading/unloading of the truck being interrupted.

A further subject of the present application is a sensor system for safeguarding an automatic loading and/or unloading of a truck at a loading region, wherein the loading region has at least one access point. The sensor system has at least one optical counting device that is arranged at the at least one access point and that is configured to optically detect a number of passages of persons via the at least one access point. The sensor system is configured, during the loading and/or unloading of items to be loaded by at least one autonomous vehicle, to continuously monitor the at least one access point with the aid of the at least one optical counting device. Furthermore, the sensor system is configured to interrupt the loading and/or unloading as soon as the counting device detects a passage of at least one person via the at least one access point.

With the aid of the optical counting device, the sensor system safeguards the automatic loading and/or unloading of the truck. The optical counting device is in this respect functionally used as a safe person counter that reliably monitors the entries and exits of persons to/from the loading region. The loading region is in this respect structurally designed such that it can be entered and exited by persons only via the access point. AGVs can also cross the access point, but this is not necessarily required for the loading or unloading of the truck since items to be loaded can already be located in the loading region. The optical counting device used in the sensor system can in this respect reliably distinguish between the passage or crossing of the access point by a person and by an AGV. Via this reliable recognition and counting of persons, there is reliable knowledge about the presence of persons in the loading region at any moment, whereby it becomes possible to effect the automatic loading and unloading of a truck in an actually safe manner.

In a further development, the sensor system comprises a further optical counting device and a counter unit that is coupled to the optical counting device and the further optical counting device. The counter unit is configured to determine a total count from the number of passages detected in the respective optical counting device.

In the case of more complex geometries or a loading region that is not structurally completely enclosed, it may be necessary to provide at least one further optical counting device. It can be attached to the loading region at a further access point, or at the at least one access point if the latter extends over a region that exceeds the size of a field of view of the at least one optical counting device. In any case, the higher-ranking counter unit is provided that is coupled to both or all optical counting devices of the sensor system in order to obtain the number of persons determined by each of the optical counting devices and to form or calculate the total count therefrom. For this purpose, the counter unit is connected to the respective optical counting devices via a suitable communication interface, for example, a wireless network interface such as the Wireless Local Area Network (WLAN).

In a further development, the at least one and/or the further optical counting device in each case comprises/comprise a first measurement channel, a second measurement channel and a control unit. The first measurement channel is configured to provide a first measurement signal in dependence on a first number of passages via the at least one access point or the further access point detected by the first measurement channel. In this respect, the first measurement channel comprises a first optical sensor, in particular a camera. The second measurement channel is configured to provide a second measurement signal in dependence on a second number of passages via the at least one access point or the further access point detected by the second measurement channel. The second measurement channel comprises the first or a second optical sensor, in particular a multi-layer laser scanner. The control unit is configured to provide a result signal in dependence on a comparison of the first number with the second number. In this respect, the result signal is suitable for signaling an error condition if the first number is not equal to the second number. Furthermore, the control unit is configured to provide the first or the second number as the count or as a further count if the first number matches the second number.

Each optical counting device used within the sensor system has two measurement channels that detect the number of passages via a respective access point separately, but almost simultaneously or simultaneously. The respective determined numbers are compared in the control unit. In the event of a match, the respective number is output as the count; if there is not a match, an error condition is signaled. Said error condition can, for example, be the result of a simultaneous passage of a plurality of persons via the access point, which usually leads to a mutual concealing of these persons. A safety-related recognition is then not possible under certain circumstances, which is reflected in the differently determined numbers of the two measurement channels. However, internal hardware or software errors can also occur in a respective optical counting device and lead to the signaling of an error condition. In any case, such an error condition can be reliably recognized and a safety-oriented response can be made by interrupting the automatic loading and unloading.

In a further development, the second measurement channel comprises a classifying neural network that is trained to evaluate, according to at least one predefined feature, sensor data that are determined by the first sensor or the second sensor and that in particular comprise three-dimensional image data.

For example, internal state evaluations of the classifying neural network, which can be referred to as an AI system, are themselves used to detect the safety-relevant states that lead to the generation of an error condition. Alternatively, a secondary monitoring on the basis of conventional algorithms can be used. In an exemplary realization, a classic algorithm is used in parallel with the evaluation of the sensor data determined by the second sensor by the neural network, said classic algorithm recognizing, tracking and, if necessary, counting relevant objects in the field of view of the sensor by means of a difference from a taught background. The object information obtained using this classic algorithm can then be used for a comparison with the results of the neural network and thus for a plausibilization of the neural network. In this process, it is checked, for example, whether both evaluations have detected objects at the same points in the monitored zone, whether these objects have similar properties, whether there is a temporal consistency of the evaluation over the entire passage event and similar.

The first and/or the second optical sensor are, for example, attached overhead at the at least one or at the further access point so that an optimal person counting is possible.

In a further development, the sensor system additionally has a communication unit. The sensor system is configured to transmit at least one control signal to the at least one autonomous vehicle by means of the communication unit, wherein the control signal causes a suppression or a release of an autonomous movement of the at least one autonomous vehicle in the loading region.

For example, the sensor system transmits a stop signal to the autonomous vehicles, e.g. AGVs, located in the loading region, with the aid of the communication unit, whereby the travel movements that are normally self-controlled by the respective vehicles are suppressed. This can be the case if the sensor system detects the access of a person to the loading region. Furthermore, this can take place at the start of the loading or unloading process if it should be checked whether one or more persons are located in the loading region at this point in time. As soon as it is ensured that there is no person in the loading region, for example after evaluating the counts or the total count, the sensor system transmits a start signal as a control signal via the communication unit in order to release the autonomous movement of the AGVs in the loading region, and thus to start or continue the loading or unloading of the truck.

The communication unit in this respect substantially comprises a communication interface, for example a WLAN interface, and the protocol software required for this purpose that is known to the skilled person. If necessary, the communication interface is reused to transmit the count.

In a further embodiment, the sensor system grants, by means of the control signal, the release of the automated movement of the AGV(s) only for a limited time period. In this case, the sensor system sends further releases continuously or at periodic intervals to enable a continuous loading and unloading process. This has the advantage that error cases of the communication or of the sensor system are automatically controlled in that the release signals do not occur and the vehicle stops automatically after a short time.

In a further development, the sensor system has a display and operating unit that is configured to enable an activation of the loading and/or unloading by an operator. In particular, the display and operating unit is configured to display the count of the optical counting device and/or the further count of the further optical counting device and/or the total count.

For an embodiment in which the automatic loading and/or unloading of the truck is/are manually started or activated by an operator after the truck has docked at the loading region, the correspondingly designed operating and display unit is provided. The operator can, on the basis of the displayed counts and possibly by additionally checking the loading space of the truck by taking a closer look, activate the loading and/or unloading if there is no person in the loading region.

In a further development, the sensor system additionally comprises at least one further sensor that is configured to detect a presence of at least one person in a loading space of the truck and/or in the loading region. This at least one further sensor is in particular designed as a radar sensor.

The at least one further sensor, for example, detects the smallest movements of a person such as their heartbeat or breathing. For this purpose, the sensor is attached at a suitable location, for example at the at least one access point, when the truck is docked with its loading space at this access point and thus at the loading region. Thus, it can automatically be detected whether a person is already located in the loading space of the truck at the time of the docking. This information is then used accordingly when activating the automatic loading or unloading of the truck. Alternatively or additionally, the at least one further sensor is used to provide redundant sensor data for the sensor data determined by the counting device and to increase the safety of the automatic loading/unloading of the truck even further with the aid of this redundancy. Alternatively or additionally, the at least one further sensor is designed as a further optical 3D sensor and is attached to the loading region such that it adopts a different perspective than the field of view of the optical counting device and/or the further optical counting device. The at least one further sensor can then, for example on the occurrence of an error condition, be used to determine the cause of said error condition and to automatically continue the loading and unloading of the truck.

In one implementation option, the method described above is carried out by the described and claimed sensor system. In all other respects, the statements on the method according to the invention apply accordingly to the sensor system, in particular with respect to advantages and embodiments or further developments.

The optical counting device is described in detail in the following.

In one embodiment, the optical counting device has a first measurement channel, a second measurement channel and a control unit. The counting device is configured and set up for the use for safeguarding the above-described automatic loading and/or unloading of a truck. The first measurement channel is configured to provide a first measurement signal in dependence on a first number of passages via the at least one access point detected by the first measurement channel. The second measurement channel is configured to provide a second measurement signal in dependence on a second number of passages via the at least one access point detected by the second measurement channel. The control unit is configured to provide a result signal in dependence on a comparison of the first number with the second number. In this respect, the result signal is suitable for signaling an error condition if the first number is not equal to the second number.

In the two-channel counting device, each channel determines a number of passages via the at least one access point independently of the other channel. A passage refers to a passing through, a passing or a crossing over the access point and relates to both the direction into the loading region and the opposite direction out of the loading region. The first measurement channel determines the first number of passages, while the second measurement channel simultaneously determines the second number of passages. The result signal is adapted such that it indicates an error condition if the first number and the second number differ from one another.

The redundancy resulting from the two-channel approach of the specified counting device, in conjunction with the evaluation of the counter results reflected in the result signal, advantageously makes it possible to fulfill the requirements of functional safety. Furthermore, with the aid of the signaling of error conditions in the result signal, it becomes possible to also automatically correct an error condition, for example within the counting device.

According to a further development, the first measurement channel comprises a first sensor arrangement and a first counter connected thereto. The second measurement channel comprises the first sensor arrangement, a conversion unit connected thereto and a second counter connected thereto. Alternatively, the second measurement channel comprises a second sensor arrangement and a second counter connected thereto.

Both the first counter and the second counter are operated such that the respective counter is incremented on a passage detected in the respective measurement channel in one direction, for example into the loading region, whereas the respective counter is decremented on a detected passage in the opposite direction, i.e. out of the loading region in the present example.

The first and the second counter therefore count the passages via the access point independently of one another based on their affiliation to a respective different measurement channel. This makes it possible to recognize faulty counting events that manifest themselves in mutually deviating counts and to signal them as an error condition.

According to one possible implementation, the second measurement channel can in this respect reuse the first sensor arrangement of the first measurement channel, wherein the second measurement channel in this case comprises the conversion unit that processes the signal output by the first sensor arrangement for the second counter. Advantageously, despite the use of only one sensor arrangement, a dual-channel capability, and thus a redundancy, is realized here that fulfills the requirements of functional safety.

In the alternative embodiment, the second measurement channel comprises the second sensor arrangement and the second counter, but no conversion unit. In this alternative, a separate second sensor arrangement is provided, whereby it becomes possible to increase the redundancy even further. For example, the second sensor arrangement can be implemented differently to the first sensor arrangement.

In one embodiment, the first sensor arrangement comprises the first optical sensor and a first processing unit coupled thereto. The first optical sensor is configured to optically detect, as far as possible, all the passages via the access point and to provide a first sensor signal therefrom. The first processing unit is configured to process the first sensor signal according to at least one predefined first feature and to provide an object signal therefrom. In particular, the first optical sensor is designed as a camera.

The first optical sensor comprises a classic security camera, for example. Such a secure camera system scans its environment in three dimensions using infrared laser beams, for example. As soon as an object is located in the field of view or detection zone, the camera system reports the detection, for example by a signal change in the provided sensor signal, in this case the first sensor signal. The first processing unit evaluates the first sensor signal according to the at least one predefined feature. The first feature is, for example, predefined so that, with the object signal, all the objects detected on an exceeding of the access point are transferred that could be a person. For example, the first feature is defined in terms of a height above the ground, a spatial extent or a speed of movement. Objects that are largely clearly recognized as non-persons based on the first feature are not forwarded with the object signal. If a minimum extent of the detected object, said minimum extent being related to the image space or the metric space derived therefrom, is used as the first feature, e.g. only objects are recognized that are very small in at least one visible dimension and thus already anatomically cannot be a person. The first sensor arrangement is consequently adapted, in borderline cases when distinguishing between an object and a person, to also forward an object that may have been incorrectly recognized as a person with the object signal.

In one embodiment, the conversion unit is configured to evaluate a signal provided by the first sensor arrangement according to at least one predefined second feature and to provide a person signal therefrom.

In the design of the counting device already described above, in which the first sensor arrangement is reused in the second measurement channel, the conversion device further evaluates the signal provided by the sensor arrangement, i.e. the object signal. For this purpose, the at least one second predefined feature is used, for example, at least one specific feature for a person. Specific human contours, such as the vertical head and shoulder profile, are used for this purpose. Further examples are movement patterns typical of a person, e.g. a normal pendulum movement when walking or a recognized, non-uniform movement within the object, such as of arms moving relative to the body. As a result, for the most part, only passages that have been made by persons are forwarded with the person signal. Passages by objects that are almost certainly not a person are thus not forwarded with the person signal.

In a further development, the second sensor arrangement comprises the second optical sensor and a second processing unit coupled thereto. The second optical sensor is configured to optically detect, as far as possible, all the passages via the access point and to provide a second sensor signal therefrom. The second processing unit is configured to evaluate the second sensor signal according to at least one predefined third feature and to generate a person signal therefrom. In this respect, the second optical sensor is in particular configured as a multi-layer laser scanner.

The second optical sensor is, for example, realized as a three-dimensional lidar (Light Detection and Ranging) sensor that scans its field of view in a plurality of, for example four, spread-out positions and reliably recognizes objects. The second processing unit evaluates the second sensor signal, which is provided in this way, with respect to the at least one third predefined feature. For example, the contour of a human, in particular the head and shoulder area, is used for the third predefined feature. Consequently, with the person signal, only those passages via the access point are forwarded that fulfill the third predefined feature and that have almost certainly not been made by objects.

According to a further development, the second processing unit has the classifying neural network. Said classifying neural network is trained to evaluate the second sensor signal according to the at least one predefined third feature and to output the person signal.

For the evaluation of the 3D scan data provided with the second sensor signal, the classifying neural network is used that was trained in advance with respect to the at least one third predefined feature. This feature can be, for example, a pattern of a typical head and shoulder area of a human. The taught feature can advantageously be used by the learning system as a basis for automatically deriving complex signatures.

The second processing unit can be realized as a software or firmware module separately from the second sensor or can be integrated with it, for example, on a control module (controller) of the second optical sensor. Accordingly, the first processing unit can be realized separately from the first optical sensor can or integrated with it.

In a further development, a detection zone of the first sensor arrangement overlaps a detection zone of the second sensor arrangement. Alternatively, the detection zones of the first and the second sensor arrangement match. In this respect, a respective detection zone of the first and the second sensor arrangement covers the region of a respective access point.

The detection zone can also be designated as a field of view. It is the spatial region in which the respective sensor detects objects. The first and the second optical sensor, in each case independently of one another, for example, create a 3D depth map with the same or a different resolution and provide the respective sensor signal accordingly.

In a further development, the first counter is configured to form a first count by evaluating a signal provided by the first sensor arrangement, for example the object signal, and to feed said first count to the control unit as a first number with the first measurement signal. The second counter is configured to form a second count on the basis of the signal provided by the first sensor arrangement or on the basis of a signal provided by the second sensor arrangement, for example the person signal, and to feed said second count to the control unit as a second count with the second measurement signal.

The first counter thus counts the passages or crossing events that are supplied with the object signal. On an entry into the loading region, the first count is, for example, incremented, whereas it is decremented on an exiting from the loading region. Thus, the first count in this example shows the number of persons or objects present in the loading region at a certain point in time. The second counter is based on the first sensor signal that was further evaluated by the conversion unit or on the signal provided by the second sensor arrangement. The second count thus reflects the number, which is determined from the person signal, of persons present in the loading region at a specific point in time. The different evaluation of the respective sensor signals results requires an asymmetrical structure of the counting device. This has the result that the counts of the first and the second counter can be different. Normally, the first and the second count are the same. However, a discrepancy between the first and the second count indicates an incorrect counting event.

In a further development, the control unit is configured to provide the result signal after a settable delay time.

The comparison of the first and second counts supplied with the first and the second measurement signal possibly only takes place after a latency period in order to compensate for short-term discrepancies of the counts that can result from different response times of the optical sensors used.

In the event that it can be seen from the result signal that the second number is smaller than the first number, the control unit is configured to optionally output a difference between the second and the first number together with a warning message at the operating and display unit described above and to deactivate the first and the second measurement channel until the first and the second number are reset to zero, for example, via the operating and display unit.

In the case that the second number is smaller than the first number, the first counter has determined a higher value from the object signal, which can contain more passages under certain circumstances, than the second counter that is based on the more selective person signal. This indicates that an object was incorrectly recognized and counted as a person. The event therefore signals an error condition that is also displayed to an operator by the operating and display unit. The automatic loading and/or unloading of the truck is/are interrupted. A further detection of passages is prevented by deactivating the first and second measurement channel until the counts have been reset again. The resetting of the counts can, for example, take place manually by a person at the display and operating unit. Alternatively, a downstream independent system can automatically perform the resetting of the counts.

In a further development, the control unit is configured to output an error message at the operating and display unit if the result signal indicates that the second number is greater than the first number. The control unit is further configured to deactivate the first and the second measurement channel in this case until the first and the second number are possibly reset to zero via the operating and display unit.

If the second count determined on the basis of the more selective person signal displays a higher value than the first count determined on the basis of the more general object signal, a general system error in the counting device is present under certain circumstances. The error condition signaled by the result signal is displayed, the automatic loading and/or unloading of the truck is/are interrupted and the further detection and counting of passages is temporarily suspended. A resetting of the counts, for example manually by an authorized person, is required before the counting device is operated further.

The counting device described herein thus offers the possibility of deriving different system reactions from the specific differences of the two measurement channels that lead to different counts under certain circumstances. If the counts deviate from one another, the automated loading and/or unloading is/are interrupted. Furthermore, it can be evaluated which counter shows the higher value and a corresponding response is made. In general, both measurement channels are able to reliably count passages of persons via the access point so that the first and the second count are normally identical. There are only deviations in special cases, for example, if the features are less clear due to the taking along of objects or due to the concealment of parts of a person. The logic of the control unit is thus designed so that too few persons are never counted when entering the loading region and too many persons are never counted when leaving the loading region. Erroneous counting events are thus reduced to availability problems since the number of persons located in the unsafe region is always overestimated. In addition, the proposed solution allows erroneous counting events that have occurred under certain conditions to be corrected automatically. For example, in cases in which the available information provided by the first and the second sensor signal is not sufficient for a reliable counting. In these cases, the control unit switches off the counting device, whereby a dangerous failure is avoided.

In a further development, the counting device has a radio location system coupled to the control unit. The radio location system is configured to detect passages via the access point on the basis of radiolocation tags, also designated as tags, to classify them according to at least one predefined fourth feature and, from this, to determine a number of passages using a third counter. The control unit is furthermore configured to compare the second number with a reading of the third counter when an error condition is displayed in the result signal and, in the case of a match, to reset the first and the second number to zero.

In this further development, the counting device is supplemented and extended by the radio location system. Said radio location system can be realized as a radio frequency identification (RFID) system or as a broadband radio location system based on Ultra Wide Band (UWB) technology. The identification number transmitted by the tags makes it possible to distinguish between persons and objects. The predefined fourth feature therefore indicates an assignment between the ID transmitted by the label to either a person or an object. Accordingly, in the case of passages by persons past the access point, the third counter is incremented and decremented analogously to the counting directions of the first and the second counter. If an error condition occurs, this third counter can additionally be considered to initiate an automatic resetting of the first and the second counter. Thus, a correction of the counters can advantageously take place in real time without a loss of availability occurring.

In addition, supplementary information collected by decentralized monitoring devices, e.g. further laser scanners, in the loading region can be used when evaluating the result signal. Time series information that reflects the states before and after a passage can also be used.

The first and/or the second processing unit can be implemented in a conventional manner or on the basis of artificial intelligence as long as it is ensured that the first measurement channel determines all the passages via the access point as reliably as possible, in case of doubt also passages by non-persons, and the second measurement channel, on the other hand, determines the passages by persons more restrictively.

The embodiments and further developments mentioned can be combined with one another, unless explicitly stated or described otherwise.

The invention will be explained by way of example in the following with reference to the Figures. Elements with the same function or effect bear the same reference numerals. There are shown:

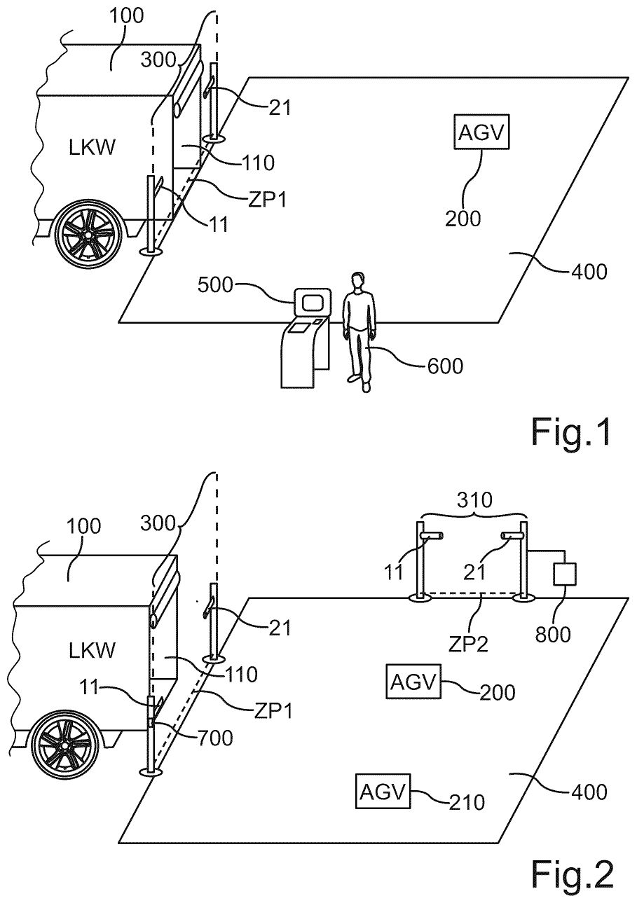

FIG. 1 a first exemplary scenario in which the proposed method or sensor system is used;

FIG. 2 a second exemplary scenario in which the proposed method or sensor system is used;

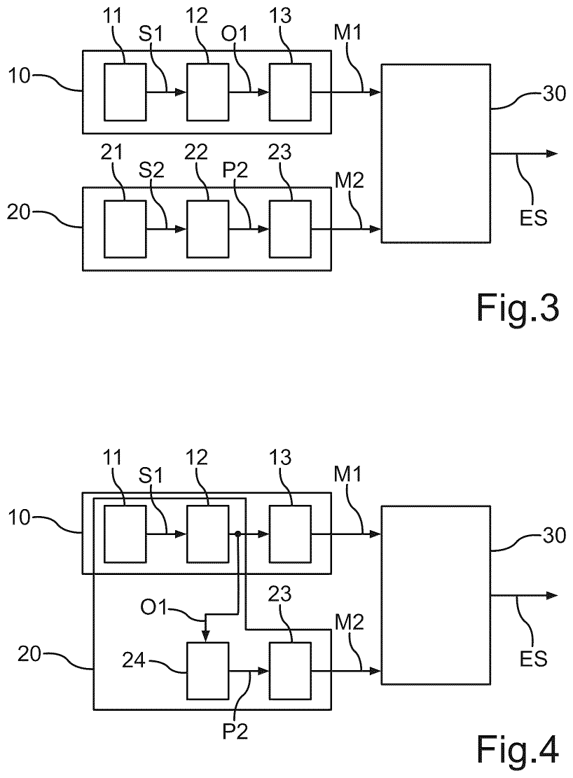

FIG. 3 a first exemplary embodiment of a counting device as proposed; and

FIG. 4 a second exemplary embodiment of the counting device as proposed.

FIG. 1 shows an exemplary scenario in which the proposed method or sensor system is used to safeguard the automatic or automated loading and/or unloading of a truck. The scenario shows a loading region 400 with an access point ZP1. The access point ZP1 is provided or safeguarded by the optical counting device 300. The counting device 300, which is part of the sensor system according to the claim, here by way of example has a first optical sensor 11 and a second optical sensor 21 that each overlook the region of the access point ZP1. In the loading region 400, there is furthermore an autonomous vehicle 200 that is used for the automatic loading/unloading of the truck 100 (LKW). Furthermore, an exemplary display and operating unit 500 is shown at which an operator 600 can, for example, read off counts determined by the optical counting device 300 and, if necessary, can manually start the beginning of the automatic loading and unloading of the truck 100 by entering a corresponding command.

According to the proposed method, the truck 100 docks at the loading region 400. The loading space 110 of the truck is opened accordingly. In the scenario shown, the truck 100 docks at the access point ZP1 monitored by the optical counting device 300. The automatic loading and/or unloading of the truck 100 with the aid of the autonomous vehicle 200 is activated. The process is continuously safeguarded in that the access point ZP1 is monitored by the optical counting device 300. The automatic loading/unloading is interrupted as soon as the counting device 300 detects a passage of a person via the access point ZP1.

FIG. 2 shows a further exemplary scenario in which the proposed method and the proposed sensor system are used. In this case, the loading region 400 has a first access point ZP1 and a second access point ZP2. The first access point ZP1 is provided with the optical counting device 300, while the access point ZP2 is provided with the optical counting device 310. Two AGVs 200, 210 are used to load and unload the truck 100. As in the scenario of FIG. 1, the truck 100 docks at the first access point ZP1. In this scenario, items to be loaded are located in loading region 400 or also in an adjacent warehouse. By passing the access point ZP2, the AGVs 200, 210 can bring items into the adjacent warehouse or pick them up from there. For persons, loading region 400 can only be entered via the first or second access point ZP1, ZP2. The optical counting devices 300 and 310 each monitor the access point to which they are attached. As soon as one of the two counting devices 300, 310 detects the passage of a person, the automatic loading and/or unloading of the truck 100 is/are interrupted.

The sensor system of FIG. 2 additionally has a counter unit 700 that is here arranged by way of example at the counting device 300. The counter unit 700 can, for example, be implemented as a software module within the control unit of the counting device 300. The counter unit 700 creates a total count from the respective numbers that are determined by the counting devices 300 and 310. In a possible realization, this total count is equal to zero if there is no person in the loading region 400. As soon as the total count 700 rises to one, for example, because one of the two counting devices 300, 310 detects the exceeding of their access point ZP1, ZP2 by a person, the automatic loading or unloading of the truck 100 is stopped. In this process, a control signal, for example a stop signal, is transmitted to each of the AGVs 200, 210, whereby the AGVs 200 and 210 are prevented from continuing to drive autonomously.

In the scenario of FIG. 2, the activation of the loading and/or unloading of the truck 100 after it has docked at the first access point ZP1 can take place in an automated manner, for example, by evaluating the total count of the counter unit 700. Furthermore, a further sensor, for example the radar sensor 800, can also be used for this purpose. It is attached to the second counting device 310 and, as described, is configured to detect the smallest movements in the monitored zone that here comprises the loading region 400 and the loading space 110 of the truck 100.

FIG. 3 shows a first exemplary embodiment of an optical counting device as proposed. The counting device has a first measurement channel 10, a second measurement channel 20 and a control unit 30. In the first measurement channel 10, a first optical sensor 11 detects, as far as possible, all the passages via an access point, such as ZP1/ZP2 from FIGS. 1 and 2. The first optical sensor 11 generates the first sensor signal S1. The first processing unit 12 evaluates the first sensor signal S1 according to at least one predefined first feature and generates the object signal O1 therefrom. The object signal O1 thus, for example, comprises all the passages across the boundary that could have been made by a person. The first counter 13 counts the passages transmitted with the object signal O1 according to their direction and provides its count with the first measurement signal M1.

Parallel thereto, a second optical sensor 21 in the second measurement channel 20, at the same time as the first measurement channel 10, likewise detects, as far as possible, all the passages via the access point and provides the second sensor signal S2. Said second sensor signal S2 is evaluated in the second processing unit 22 in accordance with at least a third predefined feature. The result is output with the person signal P2. Compared to the object signal O1, the person signal P2 is more restrictive since the third feature causes a more precise selection of the crossing events. Thus, with the person signal P2, the third counter 23 receives all the passages that, as predefined in the third feature, have been carried out as exclusively as possible by persons and, from this, said third counter determines the number of the passages. The count of the second counter 23 is transmitted with the second measurement signal M2 to the control unit 30. Said control unit compares the reading of the first counter 13 with the reading of the second counter 23 and generates a corresponding result signal ES. If the two counts do not match, an error condition is displayed with the result signal ES.

Both the first and the second optical sensor 11, 21 each comprise at least one suitable camera in accordance with the above description. For one or both optical sensors 11, 21, a plurality of cameras can also be used whose sensor signals are each combined in a suitable manner to form a signal, namely the first or the second sensor signal S1, S2. The control unit 30 can be implemented on a separate device or computer. Alternatively, the control unit 30 is realized, for example, on a chip of the first or the second optical sensor system.

FIG. 4 shows a second exemplary embodiment of the counting device as proposed. In contrast to FIG. 3, the first optical sensor system 11, 12 is reused in the second measurement channel 20. In addition, the conversion unit 24 is provided here that generates the person signal P2 from the object signal O1 by an evaluation according to the predefined second feature and feeds said person signal P2 to the second counter 23. In this respect, the second predefined feature can be defined in a similar way to the third predefined feature already described above.

Artificial intelligence methods can also be used in the conversion unit 24 to classify the passages by persons. For example, a so-called convolutional neural network is used for this purpose. It is trained in advance with synthetic or real training data. For this purpose, annotated or labeled training data are used that each show a person or an object. A classifying person and object recognition is thus made possible that forms the basis for the generation of the person signal P2.

Reference numeral list

| | |
|---|---|
| 100 | truck |
| 110 | loading space |
| 200, 210 | autonomous vehicle |
| 300, 310 | counting device |
| 400 | loading region |
| 500 | display and operating unit |
| 600 | operator |
| 700 | counter unit |
| 800 | further sensor |
| ZP1, ZP2 | access point |
| 10, 20 | measurement channel |
| 11, 21 | optical sensor |
| 12, 22 | processing unit |
| 13, 23 | counter |
| S1, S2 | sensor signal |
| O, P2, M1, M2, ES | signal |
| 30 | control unit |

1. A method for automatically loading and/or unloading a truck at a loading region, wherein the loading region has at least one access point, and wherein the at least one access point is provided with an optical counting device that is configured to optically detect a number of passages of persons via the access point,
wherein the method comprises the following steps:
docking the truck at the loading region,
activating the loading and/or unloading,
loading and/or unloading items to be loaded using at least one autonomous vehicle and while continuously monitoring the at least one access point by means of the optical counting device, wherein the loading and/or unloading is/are interrupted as soon as the counting device detects a passage of at least one person via the at least one access point.

2. The method according to claim 1,
wherein the interruption of the loading and/or unloading comprises a suppression of an autonomous movement of the at least one autonomous vehicle in the loading region by transmitting at least one control signal to the at least one vehicle.

3. The method according to claim 1,
wherein the at least one access point is provided with a further optical counting device, or wherein the loading region has a further access point that is provided with the further optical counting device, wherein the further optical counting device is configured to optically detect a further number of passages of persons via the access point or the further access point,
wherein the method further comprises:
forming a total count on the basis of the number and the further number of passages of persons via the access point and/or the further access point.

4. The method according to claim 1,
wherein the activation of the loading and/or unloading takes place by an operator or in an automated manner after the evaluation of the number determined by the at least one optical counting device or of a total count,
wherein it is ensured that no person is located in a loading space of the truck and the loading region.

5. The method according to claim 4,
wherein the activation of the loading and/or unloading takes place by an operator or in an automated manner after the evaluation of the number determined by the at least one optical counting device or of a total count using at least one further sensor.

6. The method according to claim 5,
wherein the further sensor is a radar sensor.

7. The method according to claim 1,
wherein the activation of the loading and/or unloading comprises releasing the autonomous movement of the at least one autonomous vehicle in the loading region by transmitting at least one further control signal and starts the detection of the number of passages via the at least one access point.

8. The method according to claim 1,
wherein the optical detection of the number or the further number of passages of persons via the access point comprises the following in each case:
detecting a first number of passages via the access point using a first measurement channel of the respective optical counting device,
simultaneously detecting a second number of passages via the access point using a second measurement channel of the optical counting device,
comparing the first number with the second number,
providing a result signal on the basis of the comparison, wherein the result signal indicates an error condition when the first number is not equal to the second number,
providing the first or the second number as the count of the optical counting device if the first number matches the second number.

9. The method according to claim 8,
wherein the detection of the second number of passages via the access point using the second measurement channel of the optical counting device comprises an evaluation of sensor data that are determined in the second measurement channel and that in particular comprise three-dimensional image data, wherein the evaluation takes place using artificial intelligence methods, in particular using a classifying neural network that is trained to evaluate the determined sensor data according to at least one predefined feature.

10. The method according to claim 8,
further comprising evaluating the result signal of the optical counting device and interrupting the loading and/or unloading if the result signal indicates an error condition,
wherein the evaluation of the result signal comprises a comparative check of sensor data that are determined in the first and the second measurement channel at the same time in each case.

11. A sensor system for safeguarding an automatic loading and/or unloading of a truck at a loading region, wherein the loading region has at least one access point,
wherein the sensor system has at least one optical counting device that is arranged at the at least one access point and that is configured to optically detect a number of passages of persons via the at least one access point, wherein the sensor system is configured, during the loading and/or unloading of items to be loaded by at least one autonomous vehicle, to continuously monitor the at least one access point with the aid of the at least one optical counting device,
wherein the sensor system is further configured to interrupt the loading and/or unloading as soon as the counting device detects a passage of at least one person via the at least one access point.

12. The sensor system according to claim 11,
further comprising a further optical counting device and a counter unit that is coupled to the optical counting device and the further optical counting device and that is configured to determine a total count from the number of passages detected in the respective optical counting device.

13. The sensor system according to claim 11,
wherein the at least one and/or the further optical counting device in each case comprises/comprise the following:
a first measurement channel for providing a first measurement signal in dependence on a first number of passages via the at least one access point or the further access point detected by the first measurement channel,
wherein the first measurement channel comprises a first optical sensor,
a second measurement channel for providing a second measurement signal in dependence on a second number of passages via the at least one access point or the further access point detected by the second measurement channel, wherein the second measurement channel comprises the first optical sensor or a second optical sensor, and
a control unit for providing a result signal in dependence on a comparison of the first number with the second number, wherein the result signal is suitable for signaling an error condition if the first number is not equal to the second number,
wherein the control unit is furthermore configured to provide the first or the second number as the count or a further count if the first number matches the second number.

14. The sensor system according to claim 13,
wherein the first optical sensor is a camera.

15. The sensor system according to claim 13,
wherein the second optical sensor is a multi-layer laser scanner.

16. The sensor system according to claim 13,
wherein the second measurement channel comprises a classifying neural network that is trained to evaluate, according to at least one predefined feature, sensor data that are determined by the first sensor or the second sensor.

17. The sensor system according to claim 16,
wherein the sensor data comprise three-dimensional image data.

18. The sensor system according to claim 11,
further comprising a communication unit,
wherein the sensor system is configured to transmit at least one control signal to the at least one autonomous vehicle by means of the communication unit, wherein the control signal causes a suppression or a release of an autonomous movement of the at least one autonomous vehicle in the loading region.

19. The sensor system according to claim 12,
further comprising a display and operating unit that is configured to enable an activation of the loading and/or unloading by an operator.

20. The sensor system according to claim 19,
wherein the operating unit is configured to display the count of the optical counting device and/or the further count of the further optical counting device and/or the total count.

21. The sensor system according to any one of the claim 12,
further comprising at least one further sensor that is configured to detect a presence of at least one person in a loading space of the truck and/or in the loading region.

22. The sensor system according to claim 21,
wherein the at least one further sensor is a radar sensor.
